(19) United States
(12) Patent Application Publication
(10) Pub. No.: US 2014/0279597 A1
(43) Pub. Date: Sep. 18, 2014

(54) AUTOMATED TRANSFER OF A UNIQUE IDENTIFIER FOR A CONSUMER ELECTRONICS DEVICE

(71) Applicant: GENERAL INSTRUMENT CORPORATION, Horsham, PA (US)

(72) Inventor: Thomas F. Kister, Chalfont, PA (US)

(73) Assignee: GENERAL INSTRUMENT CORPORATION, Horsham, PA (US)

(21) Appl. No.: 13/831,096

(22) Filed: Mar. 14, 2013

(51) Int. Cl. G06Q 30/00

(52) U.S. Cl. CPC G06Q 30/018
USPC 705/317

(57) ABSTRACT

A method for automated transfer of the unique ID of a consumer electronics device (CED) is disclosed. The method includes initiating registration of the CED with an external entity. The CED does not have ability to complete the registration with the external entity by itself. A unique identification for the CED is obtained and provided to the external entity in order to complete the registration of the CED. Registration of the CED is initiated by executing a registration program. The unique identification is obtained using a universal plug and play (UPnP) service that includes requesting the universal identification from the CED and receiving the universal identification from the CED. The unique identification is provided to the external entity by inserting it in an associated field provided as part of registration process. Apparatus for performing the method is also disclosed.

### BACKGROUND

So called “over the top” providers enable subscribers to access content and/or services over one or more networks that they do not control. For example, an over the top (OTT) provider may provide subscribers access to content and/or services over a cable network, a phone network, a satellite network and/or the Internet. The type of content and/or services provided may include, for example, streaming audio, streaming video, social networking, and voice over IP (VoIP). Examples of OTT providers include, for example, providers of access to streaming videos (e.g., Netflix and Hulu), providers of access to streaming audio (e.g., Pandora), providers of VoIP service (e.g., Vonage), and providers of social media services (e.g., Facebook and Twitter).

A subscriber typically creates an account with the OTT provider that provides the subscriber with access to the content and/or services. Often the content and/or services provided by the OTT provider can be accessed by multiple consumer electronic devices (CEDs), including for example, computers, tablets, smart phones, TVs, DVD players, Blu-Ray players, and digital video recorders. The CEDs may have an OTT application running thereon that provides access to OTT servers and the content stored thereon and/or services provided thereby. The OTT provider may require that each CED connecting thereto is registered and associated with the subscriber account. CED devices that include a browser and a user interface device, for example computers, tablets and smart phones, may register the CED and associate it with a subscriber account as the device can access the subscribers account online and enables the subscriber to provide the information necessary to login to their account.

However, not all CEDs include a browser, a user interface, and/or are configured to perform the tasks necessary to register the device and/or associate it with a subscribers account. For example, TVs, DVD players, Blu-Ray players, and digital video recorders may not facilitate the user registering the device directly with the OTT provider and associating the device with an account.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates an example sequence diagram of a conventional manner for registering a CED, which does not have the ability to complete registration itself for any number of reasons, with an OTT provider.

FIG. 2 illustrates an example sequence diagram for registering a CED, which does not have the ability to complete registration itself for any number of reasons, with an OTT provider according to an embodiment.

FIG. 3 illustrates an example high level flow diagram for automating the registration of a CED, which does not have the ability to complete registration itself for any number of reasons, according to an embodiment.

FIG. 4 illustrates an example system where the automated transfer of the unique ID process may be implemented according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Consumer electronic devices (CEDs) having the ability to connect to an over the top (OTT) provider may include an OTT program running on the CED that provides the necessary configuration to connect thereto. In order to connect to the OTT provider, the CED may need to be registered with the OTT provider and the CED may need to be linked to a subscriber account. Some CEDs may not have the ability to complete registration and linking because, for example, they do not include a browser, they do not have an adequate user interface, and/or may not be configured appropriately. In order for these CEDs to register with the OTT provider and link to a subscriber account they need to utilize, for example, a computer, a tablet, smart phone, or other CED having a browser and user interface device (referred to hereinafter simply as browser for simplicity). A subscriber may utilize the browser to login to their OTT account and register the CED. In order to register the CED the subscriber needs to know and enter the unique ID for the CED. The subscriber may have the CED display their unique identifier and if the browser is not in close proximity to the CED, the subscriber may need to write down the unique ID. This process is inconvenient for the subscriber and is prone to errors.

FIG. 1 illustrates an example sequence diagram of a conventional manner for registering a CED, which does not have the ability to complete registration itself for any number of reasons, with an OTT provider. The sequence diagram depicts the interaction between an actor (e.g., subscriber, viewer) 100, a browser (e.g., CED with browser and user interface) 102, the CED device 104 and an OTT provider back end 106. Initially the subscriber 100 will select an OTT application 108 on the CED 104. The CED 104 will initiate application registration 110. The CED 104 knowing that registration has not occurred yet may display a registration screen that includes the unique ID for the device 112. The registration screen may also provide instructions for how to complete the registration (e.g., provide a website address where the process may be completed). The CED 104 may begin communicating with the OTT back end 106 at this point including sending a registration request including the unique ID 114. However, since the OTT back end 106 will not have any information regarding this unique ID, such as, what user account it is associated with, the registration process cannot be completed.

The subscriber 100 may then utilize the browser 102 to login to their account with the OTT provider 116 (e.g., the subscriber may use the browser to navigate to a login page of a website associate with the OTT provider and enter their login information, such as user name and password). The browser 102 may transmit the login information 118 to the OTT backend 106 and if the login is successful the OTT backend 106 may transmit an acknowledgment 120 to the browser 102 and the browser will be able to access the account of the subscriber. After the login is successful, the subscriber 100 may select device registration 122 from the OTT provider webpage presented on the browser 102. The browser 102 may send a request for a registration page 124 to the OTT backend 106 and the OTT backend 106 send the device registration page 126 to the browser 102 and the browser 102 may present it to the subscriber 100. The subscriber 100 may enter the unique ID into the webpage 128 presented on the browser 102.

The browser 102 may transmit a register device command that includes the unique ID for the CED 130 to the OTT backend 106. The OTT backend 106 may correlate the unique ID to the subscribers account 132. The OTT backend 106 may then send a message to the CED 104 acknowledging that the CED 104 has been registered 134 and may also send a message to the browser 102 acknowledging that the CED 104 has been registered 136. Once the CED 104 is registered it may display a registration screen 138. Once this process is complete the CED 104 may now access the OTT server and access content contained thereon or services provided thereby.

It should be noted that the sequence illustrated in FIG. 1 is not limited to the exact steps or order of steps. Rather, the sequence is one example of a conventional manner in which a CED, which cannot register itself for any number of reasons, may utilize a browser to perform the registration and linking to a subscriber account for an OTT provider. Regardless of the exact sequence, the process of using a browser to register and link the CED is inconvenient for the subscriber as they need to enter the unique ID into the browser. Furthermore, if the browser is not located in close proximity to the CED the subscriber will need to write down the unique ID. Such a process may also be prone to errors.

An embodiment provides a process that does not require the subscriber to enter the unique ID as part of the registration process. In an illustrative embodiment, a browser may retrieve the unique ID for the CED from the CED over a local network (e.g., home network) that the browser and CED are connected to. The browser may retrieve the unique ID utilizing, for example, a universal plug and play (UPnP) service or other IP protocol. Having the browser retrieve the unique ID enables the browser to enter the unique ID directly into the registration process. This alleviates the need for the subscriber to have to enter the unique ID and the possible need for the subscriber to write down the unique ID is the browser and the CED are not in close proximity to one another.

According to one embodiment, the retrieving of the unique ID from the CED may be included in a registration program run on the browser. The registration program may be downloaded to the browser and initiated therefrom. Alternatively, the browser may go a website for the OTT provider and initiate a registration process therefrom. The registration process may include having the browser obtain a unique ID from the CED.

FIG. 2 illustrates an example sequence diagram for registering a CED, which does not have the ability to complete registration itself for any number of reasons, with an OTT provider according to an embodiment. The sequence diagram depicts the interaction between an actor (e.g., subscriber, viewer) 200, a browser (e.g., CED with browser and user interface) 202, the CED device 204 and an OTT provider back end 206. Initially the subscriber 200 initiates a registration program 208 on the browser 202. The browser 202 may then request a unique ID 210 from the CED 204. It should be noted that if a local network includes a plurality of CEDs, the browser may provide a list of the CEDs for the subscriber to select from. Alternatively, the subscriber 200 may identify the CED 204 as part of the initiation of the registration program 208. In response to receiving the request 210, the CED 204 may provide the browser 202 with its unique ID 212 (e.g., transmit the unique ID to the browser 202). As noted above the request for the unique ID and the transmission of the unique ID may be performed using UPnP service or other IP protocols.

Once the CED 204 provides the browser 202 with the unique ID, the CED 204 may initiate communications with the OTT CED 206 including sending a registration request including the unique ID 214. However, since the OTT back end 206 will not have any information regarding this unique ID, such as, what user account it is associated with, the registration process cannot be completed.

Based on the unique ID received, the browser 202 may present the subscriber 200 with a device registration page 216. The device registration page 216 may include the unique ID already entered in the appropriate field. The subscriber 200 may enter their account information (e.g., username, password) into the registration page 218. According to one embodiment, if the registration program is loaded on the browser 202 the program may already have the subscriber account information (e.g., username, password) embedded therein so that the subscriber does not need to enter that data. In this embodiment, the subscriber 200 may simply submit the registration form 218 that already includes account information and unique ID embedded therein.

The browser 202 may submit the device registration including account information and unique ID 220 to the OTT backend 206. The OTT backend 206 may utilize the registration information to validate the account (add unique ID and associate the unique ID to the subscriber account) 222. Once the account is validated, the OTT backend 206 may transmit an acknowledgment that the CED registration is complete 224 to the CED 204. The OTT backend 206 may transmit an acknowledgment that the CED has been associated with the subscriber account 226 to the browser 202 which may present a confirmation 228 to the subscriber 200.

It should be noted that the sequence illustrated in FIG. 2 is not limited to the exact steps or order of steps. Rather, the sequence is one example of a how a browser may retrieve a unique ID for a CED, which cannot register itself for any number of reasons, and automatically populate the unique ID in a registration and association process. Regardless of the exact sequence, the use of a browser to obtain and automatically include the unique ID in the registration and association process streamlines the process and removes a step that was inconvenient to the subscriber and prone to errors.

The retrieving of the unique ID has been discussed as being part of a program that either resides on the browser or on a website for the provider. According to one embodiment, the retrieving of the unique ID from the CED may be a program or command that can be run at any point on the browser and need not be embedded in a specific program (e.g., registration program). For example, a subscriber may utilize a browser to access their OTT account and may request device registration once in their account (see for example 122 of FIG. 1). When the subscriber gets to the point in the registration process where they need to enter the unique ID (see for example 122 of FIG. 1) the subscriber may initiate a program or command to retrieve the unique ID. According to one embodiment, the unique ID may be presented on the browser so that the subscriber can copy the unique ID and paste it into the registration page. According to one embodiment, the unique ID may be presented in a field that the subscriber was in when the program or command was executed (e.g., the unique ID field) so that the data is populated where needed.

FIG. 3 illustrates an example high level flow diagram for automating the registration of a CED, which does not have the ability to complete registration itself for any number of reasons, according to an embodiment. The process begins with a user initiating registration of a CED device 310. The registration may be initiated on a browser. The registration may be initiated, according to one embodiment, by activating a registration program stored on the device including the browser. According to one embodiment the registration may be initiated by selecting registration from a website associated with a provider (e.g., OTT provider) that the CED is being registered with.

Once the registration is initiated, the browser may obtain a unique ID for the CED 320. The browser may request the unique ID from the CED and the CED may provide unique ID using a UPnP service or other IP protocol. The browser may be directed to initiate the process of obtaining the unique ID by the registration program, according to one embodiment. According to one embodiment, the process of obtaining the unique ID for the CED may be initiated by activating a program or command while in the process of registering the CED.

Once the unique ID for the CED is obtained by the browser, it is included in the registration process 330. For example, the unique ID is populated in the appropriate field of a registration form or is included in a registration message sent to the provider. According to one embodiment, the unique ID is automatically included in the registration process (e.g., embedded in appropriate field). According to one embodiment, the unique ID is presented on the browser so that the browser can copy the unique ID and paste it in the appropriate place in the registration process (e.g., embedded in appropriate field).

The use of a browser obtaining a unique ID for a CED and having the browser populate the unique ID in a field enables for an automated transfer of the unique ID for the CED. The automated transfer of the unique ID process has been defined with respect to registering a CED device with an OTT provider and associating the CED with a subscriber account. However, the automated transfer of the unique ID process is in no way limited thereby. Rather, the automated transfer of the unique ID process can be utilized for any number of tasks associated with the CED.

For example, the process may be used to register for a warranty for the CED. A user may buy, for example, an Internet enabled refrigerator and connect the refrigerator to their local network. In order to register the warranty, the user may need the unique ID for the refrigerator. This process enables a browser to obtain the unique ID for the refrigerator and populate the unique ID in the appropriate field in a registration process. According to one embodiment, a browser may have a registration program associated with, for example, the manufacturer of the refrigerator contained thereon that when executed initiates the registration process and the obtaining of the unique ID. According to one embodiment, the browser may be used to go to a website associated with the refrigerator where the registration process will be imitated.

FIG. 4 illustrates an example system where the automated transfer of the unique ID process may be implemented according to an embodiment. The system 400 includes a local area network 410 where a router 415 is utilized to connect local networked devices together and to provide connectivity to an external network 440. The local networked devices may include one or more devices having a browser 420 and one or more CEDs not having browser capability 430. The one or more device having a browser 420 may include, for example, computers, tablets, and smart phones. The one or more CEDs not having browser capability 430 may include, for example, TVs, Blu-Ray players and home appliances including for example, refrigerators, microwaves, and coffee makers. External entities, such as OTT providers 450 and other 3^{rd} parties 460, may be connected to the network 440 and accessible to the one or more devices having a browser 420 and/or the one or more CEDs not having browser capability 430. For example, as previously discussed a CED 430 (e.g., TV) may be capable of receiving content and/or services from an OTT provider 450.

A browser 420 may be utilized to perform the automatic transfer the unique ID process. For example, the browser 420 may be able to obtain the unique ID for a CED 430 and utilize the unique ID in a certain process, for example, registration of the CED 430. The registration of the CED 430 may be, for example, for warranty purposes (e.g., register with other 3rd party 460) or for subscription purposed (e.g., register with OTT 450).

### CONCLUSION

The above referenced devices for carrying out the above methods can physically be provided on a circuit board or within another electronic device and can include various processors, microprocessors, controllers, chips, disk drives, and the like. It will be apparent to one of ordinary skill in the art that the modules, processors, controllers, units, and the like may be implemented as electronic components, software, hardware or a combination of hardware and software. Some embodiments provide the interactive user interface discussed above on a mobile device, smartphone, tablet computer, laptop or desktop computer, or other type of computing or processing device. While some devices and processors may be described or depicted herein as separate entities, the functions may be combined into fewer or greater number of physical entities.

Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

While the principles of the invention have been described above in connection with specific devices, apparatus, systems, and methods, it is to be clearly understood that this description is made only by way of example and not as limitation. One of ordinary skill in the art will appreciate that various modifications and changes can be made without departing from the scope of the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising
initiating registration of a consumer electronics device (CED) with an external entity, wherein the CED does not have ability to complete the registration with the external entity by itself;
obtaining a unique identification for the CED; and
providing the unique identification to the external entity in order to complete the registration of the CED.

2. The method of claim 1, wherein the initiating registration includes executing a registration program.

3. The method of claim 2, wherein the registration program is stored on a device having a browser and performing the method.

4. The method of claim 2, wherein the registration program is provided by the external entity.

5. The method of claim 2, wherein the obtaining the unique identification is initiated by the registration program.

6. The method of claim 1, wherein the obtaining the unique identification is initiated by activating a program during a registration process.

7. The method of claim 1, wherein the obtaining the unique identification is a universal plug and play (UPnP) service.

8. The method of claim 1, wherein the obtaining the unique identification includes requesting the universal identification from the CED and receiving the universal identification from the CED.

9. The method of claim 1, wherein the providing the unique identification includes inserting the unique identification in an associated field provided as part of a registration process.

10. The method of claim 1, wherein the providing the unique identification includes providing the unique identification in a registration message sent to the external entity.

11. The method of claim 1 performed by a device networked to the CED and having a browser.

12. The method of claim 1, wherein the external entity is an over the top (OTT) provider.

13. The method of claim 12, wherein the registration includes registering the unique identification of the CED and associating the CED with a subscriber account.

14. The method of claim 1, wherein the registration includes registering a warranty for the CED.

15. A non-transitory computer readable medium comprising stored instructions which, when executed by a processor, cause the processor to:
initiate registration of a consumer electronics device (CED) with an external entity, wherein the CED does not have ability to complete the registration with the external entity by itself;
obtain a unique identification for the CED; and
provide the unique identification to the external entity in order to complete the registration of the CED.

16. The non-transitory computer readable medium of claim 15, wherein the stored instructions, when executed by the processor, cause the processor to obtain the unique identification using a universal plug and play (UPnP) service.

17. The non-transitory computer readable medium of claim 15, wherein the stored instructions, when executed by the processor, cause the processor to obtain the unique identification by requesting the universal identification from the CED and receiving the universal identification from the CED.

18. The non-transitory computer readable medium of claim 15, wherein the stored instructions, when executed by the processor, cause the processor to provide the unique identification by inserting the unique identification in an associated field provided as part of a registration process.
